(19) United States
(12) Patent Application Publication
(10) Pub. No.: US 2026/0340617 A1
(43) Pub. Date: Oct. 29, 2026

(54) SYSTEM AND METHOD OF INITIATING POINT-OF-SALE (POS) PAYMENT TRANSACTION

(71) Applicant: Olga VENCHEVA, Mississauga Ontario (CA)

(72) Inventor: Olga VENCHEVA, Mississauga Ontario (CA)

(21) Appl. No.: 19/186,681

(22) Filed: Apr. 23, 2025

(51) Int. Cl. G06Q 20/32; G06Q 20/20; G06Q 20/40

(52) U.S. Cl. CPC G06Q 20/3223; G06Q 20/20; G06Q 20/4014

(57) ABSTRACT

The present invention relates to the initiation and processing of Point-of-Sale (POS) payment transactions using enhanced security protocols to mitigate vulnerabilities and prevent unauthorized access to sensitive payment data. The present invention represents a system and method of initiating POS payment transactions, which provide an improvement of the technological field of contactless payments by adapting and integrating advanced security techniques similar to the ones that are used in online (web) payments into on-site POS payments to enhance cybersecurity, while maintaining the convenience and simplicity of the payment process at the consumer's end. In particular, according to the suggested techniques, a payment transaction data package being at least partially transmitted from the payer's mobile device to the payment server using parallel network communication pathways at least partially distinct in applied network communication protocols.

### FIELD OF THE INVENTION

The present invention relates to the field of contactless payment systems and methods. Specifically, it pertains to the initiation and processing of Point-of-Sale (POS) payment transactions using enhanced security protocols to mitigate vulnerabilities and prevent unauthorized access to sensitive payment data.

### BACKGROUND OF THE INVENTION

Near Field Communication (NFC) technology has revolutionized contactless payments, offering a convenient and efficient way for consumers to make transactions. In traditional NFC payment schemes, such as the EMV (Europay, MasterCard, and Visa) protocol, payment data is transferred from the NFC card to the payment server via a Point-of-Sale (POS) terminal. To ensure security, this data, which includes sensitive information such as account numbers and transaction details, is transmitted along with an authentication cryptogram calculated by the mobile device based on the transaction details. The server then calculates its own version of the cryptogram using the payment data and compares it to the received cryptogram to verify the transaction's legitimacy.

However, these widely applied schemes have significant security vulnerabilities. While functional, they leave the payment data vulnerable to interception and manipulation by malicious actors. Known attacks, such as Man-in-the-Middle (MITM) and replay attacks, exploit these vulnerabilities, posing significant risks to the security and privacy of users.

Alternatively, online (web) payment transactions now employ various Two-Factor Authentication (2FA) methods, requiring payment confirmation via two independent communication channels. For instance, receiving a one-time code via SMS protocol, which is then entered manually or automatically in an online form to be verified via an internet communication channel. POS payment schemes, however, lack the security benefits of such online payment techniques. Nonetheless, integrating techniques conceptually similar to 2FA into POS payments is challenging, as security enhancements must not compromise the seamlessness and convenience of the contactless payment process as it is conducted today.

### SUMMARY OF THE INVENTION

Accordingly, there is a need for a system and method of initiating POS payment transactions, which would provide an improvement of the technological field of contactless payments by adapting and integrating advanced security techniques similar to the ones that are used in online (web) payments into on-site POS payments to enhance cybersecurity, while maintaining the convenience and simplicity of the payment process at the consumer's end.

The present invention aims to address the previously mentioned issues of the prior art and achieve the declared objectives.

In the general aspect, the invention may be directed to a method of initiating a point-of-sale (POS) payment transaction by a payment server. The method may include receiving, from a payer's mobile device, a payment transaction data package comprising: (i) payer's payment credentials data; and (ii) an authentication cryptogram generated, by the payer's mobile device, based on the payer's payment credentials data and a transaction-specific data uniquely identifying the POS payment transaction, said payment transaction data package being at least partially transmitted from the payer's mobile device to the payment server using parallel network communication pathways at least partially distinct in applied network communication protocols and comprising at least one first pathway involving data transmission through a POS terminal device, and at least one second pathway not involving data transmission through the POS terminal device. The method may further include: verifying the authentication cryptogram to ensure that the payer's payment credentials data are authentic and intended to be used for the POS payment transaction; and initiating the POS payment transaction using the payer's payment credentials data.

In another general aspect, the invention may be directed to a system for initiating a point-of-sale (POS) payment transaction. The system may include a payment server, a POS terminal device and a payer's mobile device, each comprising: a non-transitory memory module, wherein modules of program instructions are stored, and at least one processor associated with the memory module, and configured to execute the modules of program instructions; whereupon execution of said modules of program instructions the processors of the payment server, the POS terminal device, and the payer's mobile device are configured to transmit, from the payer's mobile device to the payment server, a payment transaction data package, by transmitting at least part thereof using parallel network communication pathways at least partially distinct in applied network communication protocols and comprising at least one first pathway involving data transmission through the POS terminal device, and at least one second pathway not involving data transmission through the POS terminal device, said payment transaction data package comprising: (i) payer's payment credentials data; and (ii) an authentication cryptogram generated, by the payer's mobile device, based on the payer's payment credentials data and a transaction-specific data uniquely identifying the POS payment transaction. Further, upon execution of the program instructions, the processor of the payment server is further configured to: verify the authentication cryptogram to ensure that the payer's payment credentials data are authentic and intended to be used for the POS payment transaction; and initiate the POS payment transaction using the payer's payment credentials data.

In some embodiments, the authentication cryptogram may be transmitted via both the at least one first pathway and the at least one second pathway. Said verifying the authentication cryptogram may include verifying that the authentication cryptogram transmitted via the at least one first pathway matches the authentication cryptogram transmitted via the at least one second pathway.

In some embodiments, said transaction-specific data may include: (i) a first transaction-specific data element generated by the POS terminal device; and (ii) a second transaction-specific data element generated by the payer's mobile device. The method may further include transmitting the payment transaction data package from the payer's mobile device to the payment server, including, within the first pathway: establishing a short-range wireless communication channel between the payer's mobile device and the POS terminal device; transmitting, from the POS terminal device to the payers'mobile device, via the established short-range wireless communication channel, the first transaction-specific data element; generating, by the payer's mobile device, the second transaction-specific data element; generating, by the payer's mobile device, the authentication cryptogram, based on the payer's payment credentials data, the first transaction-specific data element and the second transaction-specific data element; transmitting, from the payer's mobile device to the POS terminal device, via the established short-range wireless communication channel, the authentication cryptogram; and transmitting, by the POS terminal device to the payment server, via a first secure network communication channel, the authentication cryptogram, in association with the first transaction-specific data element.

In some embodiments of the method, said transmitting the payment transaction data package from the payer's mobile device to the payment server further includes, within the second pathway, establishing a second secure network communication channel between the payer's mobile device and the payment server; transmitting, from the payer's mobile device to the payment server via the established second secure network communication channel, the authentication cryptogram in association with the first transaction-specific data element. Said verifying the authentication cryptogram may further include verifying that the authentication cryptogram transmitted via the at least one first pathway matches the authentication cryptogram transmitted via the at least one second pathway, based on the association with the first transaction-specific data element.

In some embodiments of the method, the payer's payment credentials data may be transmitted via the at least one first pathway; and said verifying the authentication cryptogram may further include: generating, by the payment server, a server version of the authentication cryptogram, based on the payer's payment credentials data and the transaction-specific data; verifying that the server version of the authentication cryptogram matches the authentication cryptogram transmitted via the at least one first pathway; and transmitting a request to the mobile device to transmit the authentication cryptogram via the at least one second pathway, provided that the server version of the authentication cryptogram matches the authentication cryptogram transmitted via the at least one first pathway, wherein the authentication cryptogram is transmitted via the at least one second pathway upon the request.

In some embodiments, the short-range wireless communication channel may be established using at least one of: (i) Near Field Communication (NFC) protocol; (ii) Bluetooth protocol; (iii) Wi-Fi protocol; the first secure network communication channel may be established using at least one of: (i) Transmission Control Protocol/Internet Protocol (TCP/IP); (ii) ISO 8583 over TCP/IP; (iii) Virtual Private Network (VPN) over TCP/IP; and the second secure network communication channel may be established using at least one of: (i) TCP/IP; and (ii) VPN over TCP/IP.

In some embodiments, said first transaction-specific data element may include at least one of (i) a unique identifier of the POS terminal device; (ii) a random one-time-use code.

In some embodiments, said second transaction-specific data element may include at least one of (i) a transaction timestamp; (ii) a unique identifier of the payer's mobile device (iii) a random one-time-use code; (iv) a transaction counter.

In some embodiments, the authentication cryptogram may be transmitted via the at least one first pathway; and the payer's payment credentials data may be transmitted via the at least one second pathway. In some embodiments of the method, said verifying the authentication cryptogram may include: generating, by the payment server, a server version of the authentication cryptogram, based on the payer's payment credentials data and the transaction-specific data; verifying that the server version of the authentication cryptogram matches the authentication cryptogram transmitted via the at least one first pathway.

In some embodiments, said transaction-specific data may include: (i) a first transaction-specific data element generated by the POS terminal device; and (ii) a second transaction-specific data element generated by the payer's mobile device. The method may further include transmitting the payment transaction data package from the payer's mobile device to the payment server, including, within the first pathway: establishing a short-range wireless communication channel between the payer's mobile device and the POS terminal device; transmitting, from the POS terminal device to the payers'mobile device, via the established short-range wireless communication channel, the first transaction-specific data element; generating, by the payer's mobile device, the second transaction-specific data element; generating, by the payer's mobile device, the authentication cryptogram, based on the payer's payment credentials data, the first transaction-specific data element and the second transaction-specific data element; transmitting, from the payer's mobile device to the POS terminal device, via the established short-range wireless communication channel, the authentication cryptogram; transmitting, by the POS terminal device to the payment server, via a first secure network communication channel, the authentication cryptogram, in association with the first transaction-specific data element.

In some embodiments of the method, said transmitting the payment transaction data package from the payer's mobile device to the payment server may further include, within the second pathway: establishing a second secure network communication channel between the payer's mobile device and the payment server; transmitting, from the payer's mobile device to the payment server via the established second secure network communication channel, the payer's payment credentials data in association with the first transaction-specific data element; wherein the server version of the authentication cryptogram may be associated with the first transaction-specific data element; and wherein said verifying that the server version of the authentication cryptogram matches the authentication cryptogram transmitted via the at least one first pathway may be performed based on the association with the first transaction-specific data element.

In some embodiments, said payer's payment credentials data may include at least one of: (i) a cardholder information; (ii) a card number or a payment token number; (iii) a card expiry date; (iv) a Card Verification Value (CVV) or a Card Verification Code (CVC); (v) a transaction amount.

In some embodiments of the system, the processors of the payment server, the POS terminal device, and the payer's mobile device may be further configured to transmit, from the payer's mobile device to the payment server, a payment transaction data package, further by transmitting the authentication cryptogram via both the at least one first pathway and the at least one second pathway; and the processor of the payment server may be further configured to verify the authentication cryptogram by verifying that the authentication cryptogram transmitted via the at least one first pathway matches the authentication cryptogram transmitted via the at least one second pathway.

In some embodiments of the system, the processors of the payment server, the POS terminal device, and the payer's mobile device may be configured to transmit, from the payer's mobile device to the payment server, a payment transaction data package, further by: (A) within the first pathway: establishing a short-range wireless communication channel between the payer's mobile device and the POS terminal device; transmitting, from the POS terminal device to the payers'mobile device, via the established short-range wireless communication channel, the first transaction-specific data element; generating, by the payer's mobile device, the second transaction-specific data element; generating, by the payer's mobile device, the authentication cryptogram, based on the payer's payment credentials data, the first transaction-specific data element and the second transaction-specific data element; transmitting, from the payer's mobile device to the POS terminal device, via the established short-range wireless communication channel, the authentication cryptogram; transmitting, by the POS terminal device to the payment server, via a first secure network communication channel, the authentication cryptogram, in association with the first transaction-specific data element; (B) within the second pathway: establishing a second secure network communication channel between the payer's mobile device and the payment server; transmitting, from the payer's mobile device to the payment server via the established second secure network communication channel, the authentication cryptogram in association with the first transaction-specific data element. The processor of the payment server may be further configured to verify that the authentication cryptogram transmitted via the at least one first pathway matches the authentication cryptogram transmitted via the at least one second pathway, based on the association with the first transaction-specific data element.

In some embodiments of the system, the processors of the payment server, the POS terminal device, and the payer's mobile device may be configured to transmit, from the payer's mobile device to the payment server, a payment transaction data package, further by transmitting the payer's payment credentials data via the at least one first pathway. The processor of the payment server may be further configured to verify the authentication cryptogram further by: generating, by the payment server, a server version of the authentication cryptogram, based on the payer's payment credentials data and the transaction-specific data; verifying that the server version of the authentication cryptogram matches the authentication cryptogram transmitted via the at least one first pathway; transmitting a request to the mobile device to transmit the authentication cryptogram via the at least one second pathway, provided that the server version of the authentication cryptogram matches the authentication cryptogram transmitted via the at least one first pathway. The processors of the payment server and the payer's mobile device may be further configured to transmit, from the payer's mobile device to the payment server via the established second secure network communication channel, the authentication cryptogram upon the request.

In some embodiments of the system, the processors of the payment server, the POS terminal device, and the payer's mobile device may be configured to transmit, from the payer's mobile device to the payment server, a payment transaction data package, by: transmitting the authentication cryptogram via the at least one first pathway; and transmitting the payer's payment credentials data via the at least one second pathway. Said at least one processor of the payment server may be further configured to verify the authentication cryptogram by: generating, by the payment server, a server version of the authentication cryptogram, based on the payer's payment credentials data and the transaction-specific data; and verifying that the server version of the authentication cryptogram matches the authentication cryptogram transmitted via the at least one first pathway.

### BRIEF DESCRIPTION OF THE DRAWINGS

The invention is particularly defined and distinctly claimed in the final section of the specification. However, to better comprehend the organization, method of operation, as well as the associated essential features and improvements provided thereby, one should refer to the detailed description provided below, along with the following accompanying drawings:

FIG. 1 is a flow diagram, depicting a method of initiating POS payment transactions, according to certain embodiments;

FIG. 2 is a block diagram, depicting a computing device which may be included in a system for initiating POS payment transactions, according to certain embodiments;

FIG. 3A is a block diagram, depicting aspects of a mobile device and a payment terminal of a system for initiating POS payment transactions, according to certain embodiments;

FIG. 3B is a block diagram, depicting aspects of a payment server of the system for initiating payment transactions, according to a certain embodiment;

FIG. 3C is a block diagram, depicting aspects of a payment server of the system for initiating payment transactions, according to an alternative embodiment;

FIG. 3D is a block diagram, depicting aspects of a payment server of the system for initiating payment transactions, according to yet another alternative embodiment;

FIG. 4A is a sequence diagram, depicting aspects of a method for performing POS payment transactions, as performed by the suggested system, according to a certain embodiment;

FIG. 4B is a sequence diagram, depicting aspects of a method for performing POS payment transactions, as performed by the suggested system, according to an alternative embodiment; and

FIG. 4C is a sequence diagram, depicting aspects of a method for performing POS payment transactions, as performed by the suggested system, according to yet another alternative embodiment.

It shall be appreciated that, where considered appropriate, reference numerals may be repeated among the figures to indicate corresponding or analogous elements.

### DETAILED DESCRIPTION OF THE PRESENT INVENTION

A person skilled in the art will recognize that the present invention can take on various forms and embodiments without deviating from its fundamental concept or essential features. The embodiments provided herein should therefore be regarded as non-exclusive and illustrative rather than limiting with respect to the invention described herein. The scope of the invention shall be considered defined by the appended claims, rather than by the preceding description, and all changes that come within the meaning and range of equivalency of the claims are therefore intended to be embraced therein.

In the detailed description, specific details are presented to facilitate an understanding of the invention, although the present invention can be implemented without reliance on these specific details. For the sake of clarity, discussions pertaining to identical or analogous features or elements may not be repeated. Certain well-known methods, procedures, and components may not be explained herein to avoid obscuring the essence of the present invention. Additionally, features or elements described in relation to one embodiment may be combined with features or elements described in relation to other embodiments.

It shall be understood that, in the context of present disclosure, the terms “plurality” and “a plurality” may include, e.g., “multiple” or “two or more” and may be used to describe two or more elements. The term “set” as used herein may include one or more items.

It shall be understood that, in the present disclosure, the terms such as “user”, “cardholder”, and “consumer” refer to the same party of the payment transaction and, therefore, these terms may be used interchangeably.

It shall be understood that, in the present disclosure, the terms such as “payment terminal”, “point-of-sale terminal” and “POS-terminal” refer to the same device and, therefore, may be used interchangeably.

It shall be understood that, in the present disclosure, the terms such as “payment card”, “credit card” or “debit card” may refer to the same element and, therefore may be used interchangeably. It shall further be understood that, in the context of mobile payments, these or similar terms may refer to a “card” as a virtual data element comprising payment credentials, and not to a physical payment card.

It shall be understood that, in the context of the present invention, discussions involving terms such as, for example, “transmitting”, “receiving”, “obtaining”, “retrieving”, “processing,” “computing,” “calculating,” “determining,” “establishing”, “analyzing”, “selecting”, “training” or the like, may refer to an operation of a processor or similar electronic computing device, that operates with and transforms data represented as physical (e.g., electronic) quantities within the computer's registers, memories, or other non-transitory storage mediums into other data similarly represented as physical quantities within the computer's registers, memories, or other information non-transitory storage mediums, to perform respective operations.

It shall understood that, in the context of the present description, when referring to a specific device (e.g., mobile device, payment (POS) terminal, payment server etc.) as performing a specific action or sequence of actions, it may equally mean that this device may represent a group of devices performing this action or sequence of actions, and the action or sequence of actions may be distributed between the respective group of devices. Accordingly, in such embodiments, the group of devices may act as a single device and, therefore, may be considered equivalent to a single device. Consequently, the scope of the present invention shall be considered to cover such embodiments and shall not be limited in this respect.

In embodiments of the present invention, some steps of the claimed method may be performed using machine-learning (ML)-based models. ML-based models may be configured or “trained” for a specific task, e.g., classification or regression.

It would be apparent to one skilled in the art that various structures of machine learning (ML)-based models can be implemented without deviating from the core principles of the present invention. In certain embodiments, an ML-based model may consist of either a single ML-based model or an ensemble of ML-based models that collectively perform the same function as a single model. Therefore, considering the scope of the present invention, the aforementioned variations should be deemed equivalent.

In certain embodiments, ML-based models may be artificial neural networks (ANN).

Artificial Neural Networks (ANNs) are computational models inspired by the structure and functioning of the human brain. They are a subset of machine learning algorithms used for tasks such as classification, regression, and pattern recognition. ANNs consist of interconnected processing elements called neurons or nodes. These nodes are organized in layers and linked to work together for processing and learning from input data, thereby providing a powerful tool for solving complex problems. The links may transfer signals between nodes and may be associated with weights. The nodes and links within an ANN are represented by mathematical structures and elements, such as activation functions and matrices of data elements and weights. Training ANNs involves iteratively adjusting the weights of interconnected neurons to learn from input data including training examples. During the first training stage-forward propagation input data passes through the network, and neurons compute weighted sums, apply activation functions, and pass results to subsequent layers. The calculated loss function quantifies prediction accuracy. At the next stage-backpropagation gradients of the loss with respect to the weights are calculated, enabling weight updates. Training occurs in epochs, with data divided into smaller batches. After training, models are evaluated on validation and test datasets to assess generalization. ANNs capture intricate patterns, making them essential in modern machine learning applications. It shall be understood that the computations associated with training and inferring artificial neural networks (ANNs) are to be performed by a processor of a respective computing device.

The method embodiments described herein are not limited to any specific order or sequence unless stated otherwise. Certain method embodiments shall not be considered having any predetermined constraints as for comprising steps that may occur or be executed repeatedly, iteratively, simultaneously etc.

According to the concept of the present invention, it is suggested to use, at the POS, two “parallel” network communication channels in order to transfer, from the mobile device to the payment server, all the data required to authenticate and initiate the payment transaction (also referred to as “payment transaction data package”). As suggested, these network communication channels may be at least partially distinct in applied network communication protocols, and the first pathway may involve data transmission through a POS terminal device, while the second pathway may not involve data transmission through the POS terminal device.

The suggested approach opens new possibilities for secure payment transaction authentication and initiation, that were impossible to implement in traditional payment schemes with physical payment cards (e.g., magnetic stripe cards, chip cards (EMV), contactless cards (NFC) etc.). The application of physical payment cards was limited in regard of applied network communication channels due to the passive role of the payment card-it was able to transfer the payment transaction data package only to the POS terminal, when connected thereto). With technological progress, mobile phone obtained functionality of a “digital wallet”, emulating physical payment cards for POS payment transactions, however, the common solutions do not utilize additional technological advantages mobile phones have compared to physical payment cards. One of these functionalities is the ability to use various protocols and communication channels for data transmission.

The broad concept of the present invention encompasses multiple alternative embodiments. Similar to traditional techniques, to authenticate the payment transaction, the payer's mobile device may generate an authentication cryptogram based on the payer's payment credentials data and transaction-specific data uniquely identifying the POS payment transaction. However, the subsequent steps of the process may differ depending on the specific embodiment.

In particular, in one embodiment, it is suggested to transmit the authentication cryptogram from the payer's mobile device to the payment server via two network communication pathways: the first is traditional-over the POS terminal—and the second is via mobile network communication (e.g., LTE, 5G, etc.), using, e.g., standard TCP/IP or VPN over TCP/IP protocols. Upon receiving two copies of the authentication cryptogram via different pathways, in contrast to the common approach, the server may simply check if these two cryptograms match, to perform authentication. Furthermore, the communication via the second pathway may be initiated by the server, which, upon receiving the payment credentials data, knows the information about the payer and may determine, e.g., retrieve from the database, the information about the payer's mobile device to communicate with it. In such scenarios, if the payment credentials and the cryptogram were intercepted during transmission via the first pathway, they cannot be used in a different transaction, as the server is required to request the mobile device for the copy of the cryptogram via the second pathway. The mobile device, in turn, may simply reject the request, knowing that there is no ongoing payment transaction, as there was no recent communication and data transfer using the POS terminal device. Furthermore, even if there were a recent interaction (within another payment transaction) and the authentication cryptogram that the mobile device sends via the second pathway in response to the request, upon comparison by the payment server, will not match the cryptogram received via the first pathway, as each cryptogram was generated using transaction-specific data from different transactions. This approach thereby improves data security.

In an alternative embodiment, upon receiving the payer's payment credentials data and the authentication cryptogram via the first communication pathway (through the POS-terminal), the server may first perform a traditional authentication procedure: generating a server version of the authentication cryptogram based on the payer's payment credentials data and the transaction-specific data, and verifying that it matches the authentication cryptogram transmitted via the first pathway. However, in contrast to the traditional approach, if the verification is successful, the server may proceed with a second step of authentication—transmitting a request to the mobile device to provide the authentication cryptogram via a second communication pathway. Then, as described in the first embodiment, the server may receive the authentication cryptogram from the mobile device via the second pathway and verify that it matches the one transmitted via the first pathway. Thereby, a two-step authentication may be achieved, further improving the data security.

In yet another alternative embodiment, unlike common techniques, the payer's payment credentials data may not be transmitted via the POS terminal, as the mobile device may use a different network communication pathway for that, such as mobile network communication (e.g., LTE, 5G), employing standard TCP/IP or VPN over TCP/IP protocols (referred to herein as the ‘second’ network communication pathway). However, to ensure the payer's actual presence at the POS, the mobile device may use the first network communication pathway (involving the POS terminal) to transfer the authentication cryptogram to the server. Upon receiving both the cryptogram and the payment credentials data, the payment server may perform traditional authentication by generating a server version of the authentication cryptogram based on the payer's payment credentials data and transaction-specific data, and verifying that it matches the cryptogram received from the mobile device via the first pathway. This approach may provide a higher level of security compared to traditional techniques, as the cryptogram and payment credentials data are not transmitted together via the same network communication pathway. Since the authentication of the payment transaction requires both the cryptogram and the payment credentials data, intercepting the data transmission via one pathway alone will not provide enough information for fraudulent use.

By using authentication techniques involving network communication via two distinct pathways (at least partially distinct in applied network communication protocols), the present invention adapts and integrates advanced security measures, similar to those used in online (web) payments, into on-site POS payments. These measures can be performed in the background, remaining invisible to the user and maintaining the convenience and simplicity of the payment process for the consumer.

The aspects of the present invention are further explained in greater detail with reference to the accompanying figures.

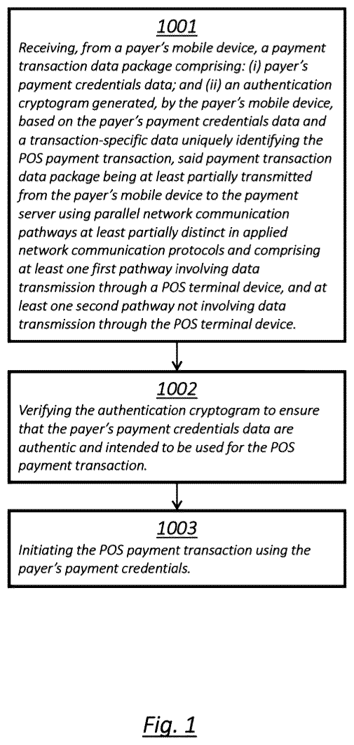

Referring now to FIG. 1, a flow diagram is presented, illustrating a method of initiating a POS payment transaction, according to certain embodiments of the present invention.

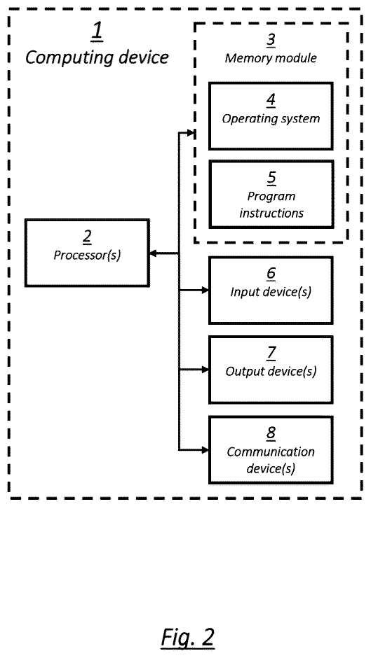

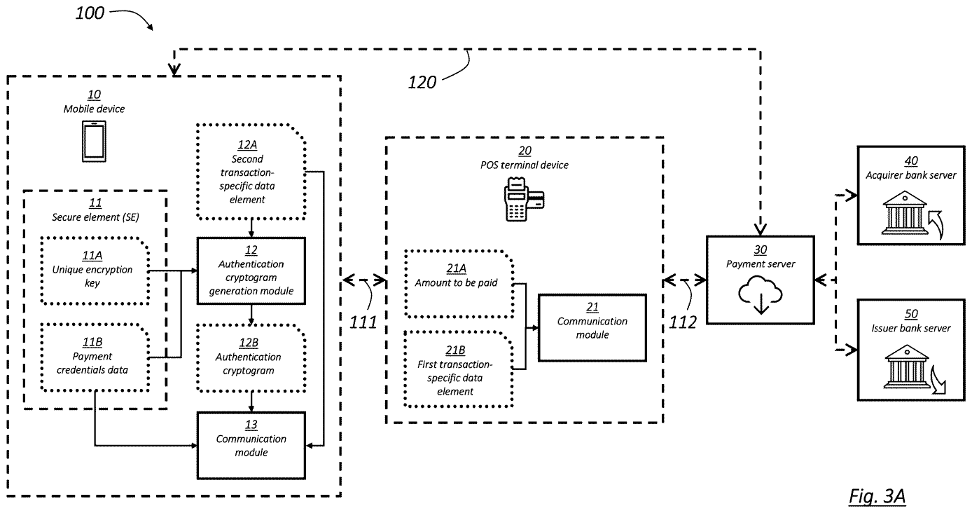

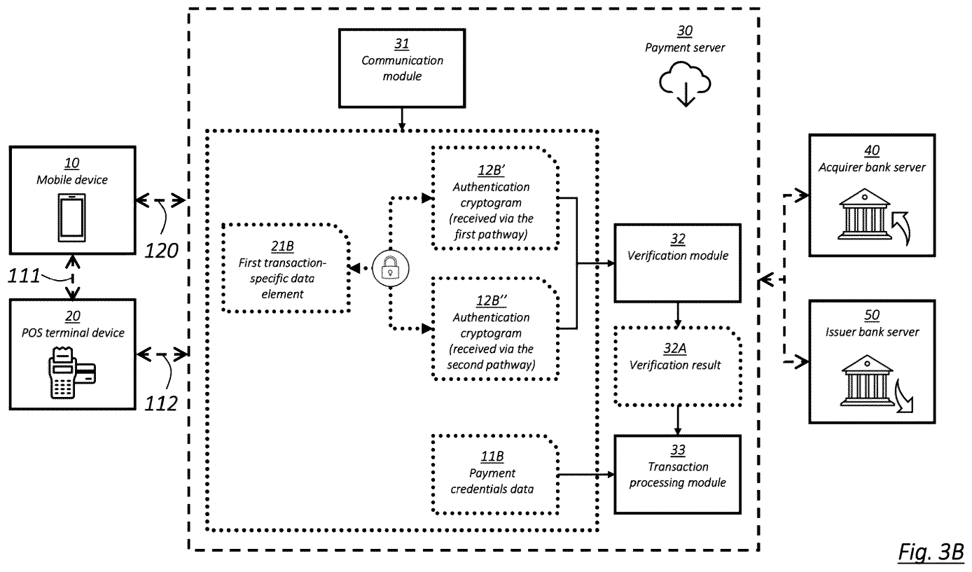

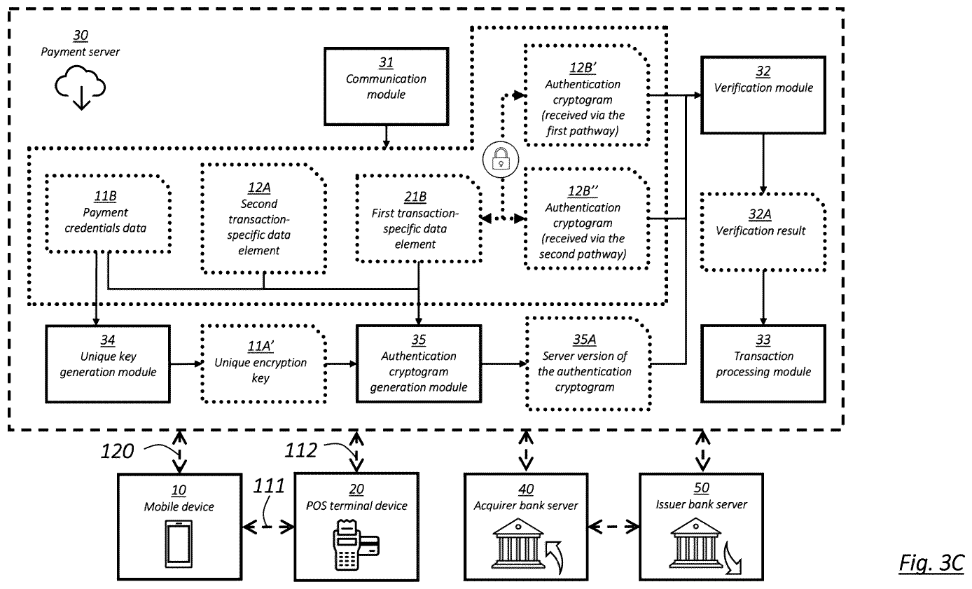

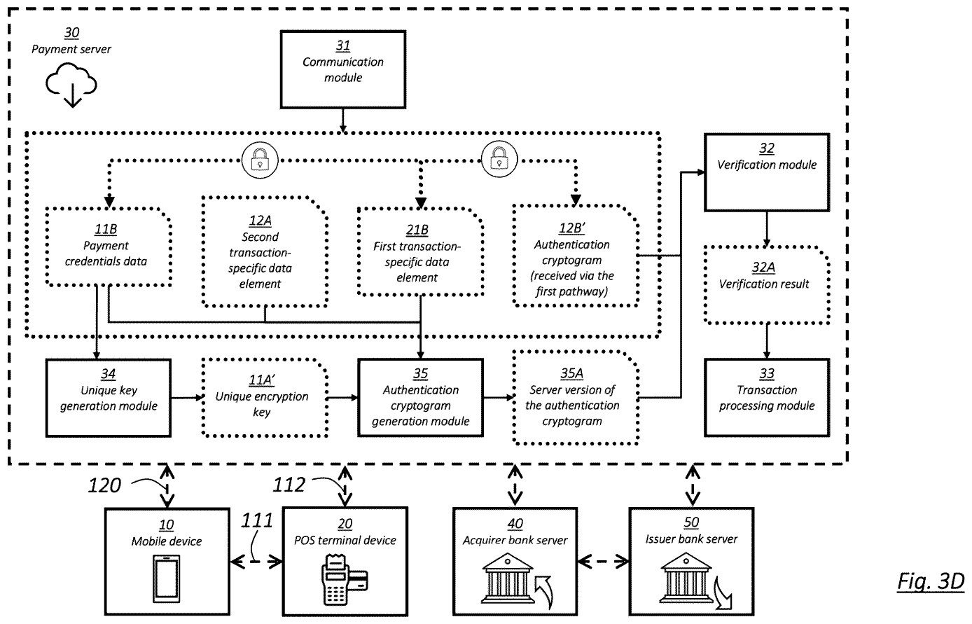

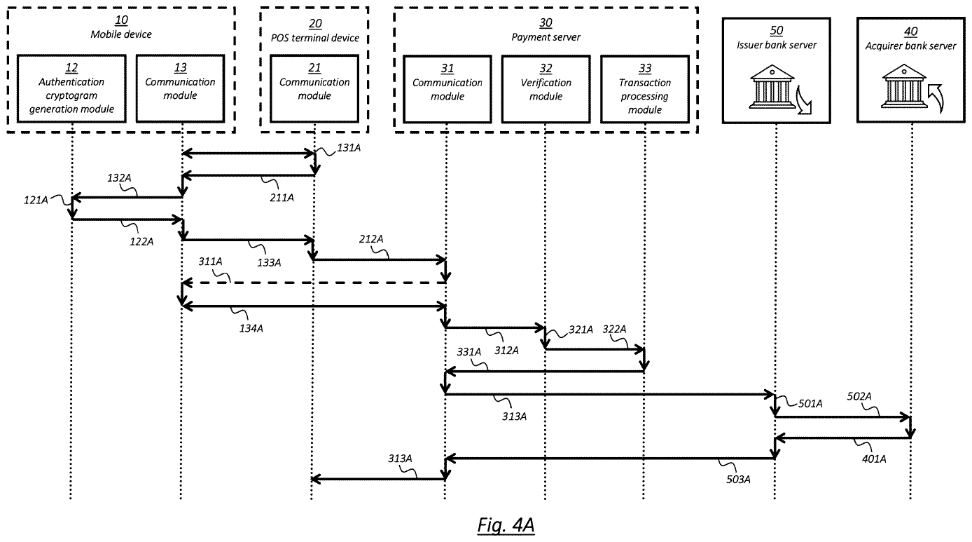

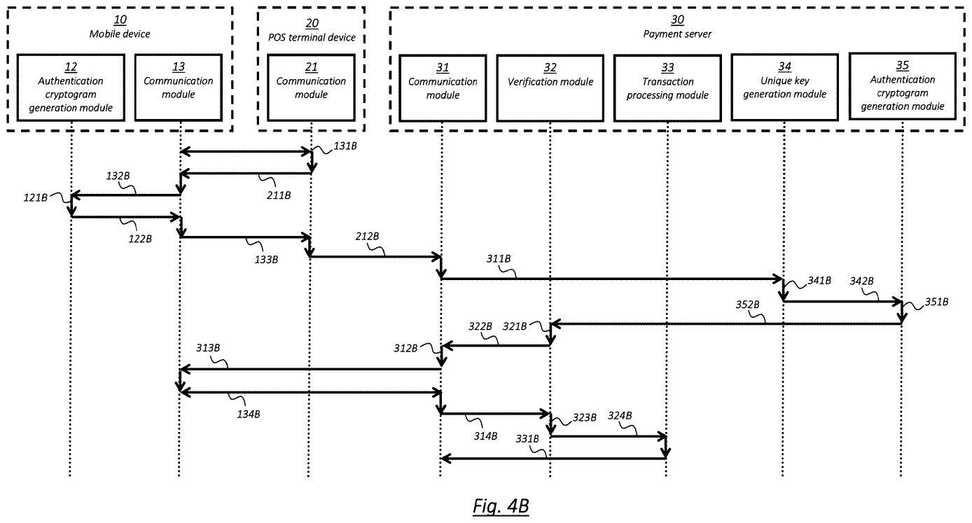

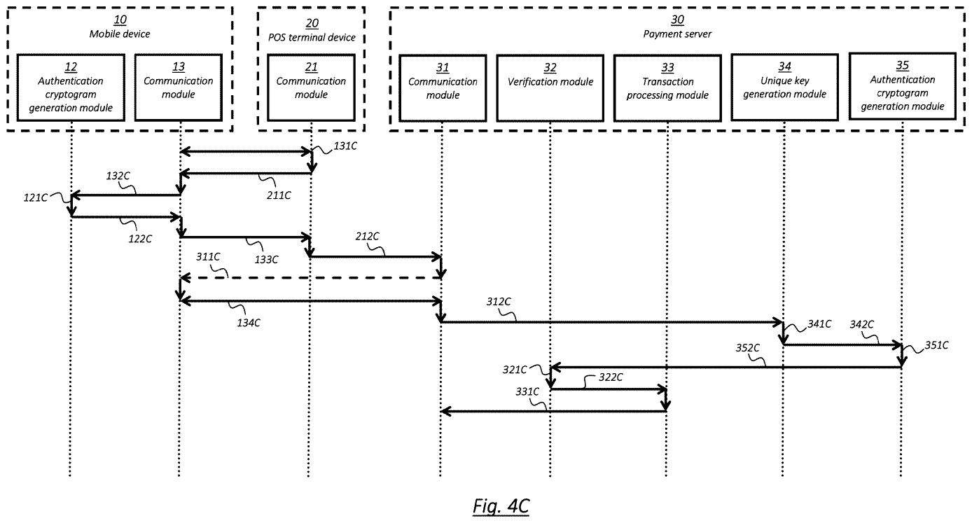

In step 1001, at least one processor (e.g., a processor 2 shown in FIG. 2, e.g., a processor of a mobile device 10, a processor of a POS terminal device 20, and a processor of a payment server 30 shown in FIGS. 3A-3D) may be operated to receive, from a payer's mobile device (e.g., the mobile device 10 shown in FIGS. 3A-3D), a payment transaction data package comprising: (i) payer's payment credentials data (e.g., the payment credentials data 11B shown in FIGS. 3A-3D); and (ii) an authentication cryptogram (e.g., an authentication cryptogram 12B, 12B′ or 12B″ shown in FIGS. 3A-3D) generated, by the payer's mobile device, based on the payer's payment credentials data and a transaction-specific data uniquely identifying the POS payment transaction (e.g., a first transaction-specific data element 21B and a second transaction-specific data element 12A shown in FIGS. 3A-3D), said payment transaction data package being at least partially transmitted from the payer's mobile device to the payment server (e.g., the payment server 30 shown in FIGS. 3A-3D) using parallel network communication pathways at least partially distinct in applied network communication protocols and comprising at least one first pathway involving data transmission through a POS terminal device (e.g., the network communication pathway indicated by elements 111 and 112, as shown in FIGS. 3A-3D), and at least one second pathway not involving data transmission through the POS terminal device (e.g., the network communication pathway indicated by the element 120, as shown in FIGS. 3A-3D). Step 1001 may be carried out by a communication module 13, a communication module 21 and a communication module 31 (as described with reference to FIGS. 3A-3D, 4A-4C).

In step 1002, at least one processor (e.g., processor 2 shown in FIG. 2, e.g., the processor of the payment server 30 shown in FIGS. 3A-3D) may be operated to verify the authentication cryptogram (e.g., the authentication cryptogram 12B′ or 12B″ shown in FIGS. 3B-3D) to ensure that the payer's payment credentials data are authentic and intended to be used for the POS payment transaction. Step 1002 may be carried out by a verification module 32 (as described with reference to FIGS. 3B-3D and 4A-4C).

In step 1003, at least one processor (e.g., the processor 2 shown in FIG. 2, e.g., the processor of payment server 30 shown in FIGS. 3A-3D) may be operated to initiate the POS payment transaction using the payer's payment credentials data (e.g., the payment credentials data 11B shown in FIGS. 3A-3D). Step 1003 may be carried out by a transaction processing module 33 (as described with reference to FIGS. 3B-3D and 4A-4C).

It should be understood that the method embodiments described herein are not constrained by any particular orders of steps thereof. Furthermore, certain method embodiments may incorporate steps that may occur or be executed simultaneously.

Aspects of the method of FIG. 1 are further clarified with reference to FIGS. 2, 3A-3D, and 4A-4C.

Referring now to FIG. 2, a block diagram is represented, depicting a computing device which may be included in the system for initiating POS payment transactions, according to certain embodiments.

FIG. 2 illustrates only a non-exclusive example of a computing device 1, and many other example embodiments of the computing device 1 may be used herein.

As shown, the computing device 1 may include one or more processor(s) 2 (or controller(s)) (e.g., Central Processing Unit (CPU), a chip etc.), a memory module 3, an operating system (OS) 4, program instructions 5, input devices 6, output devices 7, communication devices 8. Processor(s) 2 may be distributed across multiple computing devices 1. Each of components 2-8 may be interconnected via one or more busses for inter-component communications. The processor 2 may be configured to implement functionality and/or process instructions for execution within the computing device 1. The processor 2 may be capable of processing instructions 5 stored in the memory module 3, thereby carrying out the method described herein. In accordance with embodiments of the invention, the system for initiating payment transactions may include multiple computing devices 1, each acting as a respective component of the system (e.g., mobile device, server, payment terminal etc.), wherein each of the computing devices 1 may have one or more processors 2, memory modules 3, program instructions 5, input devices 6 and output devices 7.

Operating system 4 may represent a program instructions segment that is configured to, when implemented by at least one processor (e.g., processor 2), manage and control hardware resources of the computing device 1 (e.g., the memory module 3, input and output devices 6 and 7). The operating system 4 is configured to provide essential functionalities such as process scheduling, memory management, file system access, and network communication. The operating system 4 may be configured to act as an intermediary between program instructions 5 and the underlying hardware, enabling efficient execution of tasks, user interaction, and overall system stability.

The memory module 3 may be configured to store various data used by at least one component (e.g., processor 2 or input and output devices 6 and 7) of the computing device 1. The various data may include, for example, software (e.g., program instructions 5) and input data or output data for a command related thereto. By accessing data stored by the memory module 3, the processor 2 may be configured to execute program instructions 5 to implement aspects of the method for initiating POS payment transactions, as described herein. The memory module 3 may include Random Access Memory (RAM), Read-Only Memory (ROM), cache memory, Hard Disk Drive (HDD), Solid State Drive (SSD), virtual memory, flash memory, registers etc., or combination thereof.

Program instructions 5 may be an executable program code, e.g., acting as a stand-alone application, an application comprising interconnected server and terminal parts, an Application Program Interface (API) module, scripts integrated into other applications etc. Program instructions 5 may be dedicated to being executed by the processor 2 to implement various operations using input and output devices 6 and 7, memory module 3 etc., using the operating system 4. When being executed, program instructions 5 may be configured to implement various steps of the claim method of initiating POS payment transaction, as further discussed in greater detail.

Input devices 7 may receive controlling signal, command or data to be used by another component (e.g., processor 2) of the device 1, from the outside of the device 1 (e.g., from a user). Input devices 7 may include, for example, a microphone, a mouse, a keyboard, keys (e.g., buttons), a digital pen (e.g., a stylus pen), a touchscreen, a camera (having 2D or 3D capturing means, e.g., a depth camera), a fingerprint scanner etc., connected to computing device 1 using standard or specifically designed communication interfaces. Output devices 8 may output (transmit) signals, commands or data to be received and used by other computing devices 1 or to be provided to the user (e.g., as a sound, image, video, printed data etc.). Output devices 8 may include display (e.g., touchscreen), sound speaker, printer etc., connected to the computing device 1 using standard or specifically designed communication interfaces.

The communication module 8 may be configured to support establishing a direct (e.g., wired) communication channel or a wireless communication channel between the computing device 1 and other computing devices 1 and performing communication via the established communication channel. The communication module 8 may be or may include a short-range wireless communication module (e.g., using Bluetooth™, wireless-fidelity (Wi-Fi), or infrared data association (IrDA), Near-Field Communication (NFC) module etc.), a long-range communication module (such as a cellular communication module, e.g., using a cellular network, e.g., a fifth-generation (5G) network), a computer network module (e.g., using Local Area Network (LAN), Wide Area Network (WAN)), or the Internet) a Global Navigation Satellite System (GNSS) communication module, a power line communication (PLC) module, etc.

Reference is now made to: FIG. 3A depicting a block diagram of system 100 for initiating POS payment transactions, in particular aspects of mobile device 10 and POS terminal device 20, according to certain embodiments; FIG. 3B depicting a block diagram of system 100, in particular aspects of payment server 30, according to some embodiments; and FIG. 4A depicting a sequence diagram of aspects of a method for performing POS payment transactions, as performed by system 100 shown in FIG. 3A-3B, according to certain embodiments.

As shown in FIGS. 3A-3D, 4A-4C, arrows may represent flow of one or more data elements to and from system 100 or among modules or elements of system 100. It is to be acknowledged that certain arrows may have been intentionally omitted for the sake of clarity. According to certain embodiments of the invention, system 100 may be implemented as a combination of hardware and software modules. System 100 may include computing devices such as computing device 1 shown in FIG. 2, that may be adapted to execute one or more modules of program instructions (e.g., program instructions 5 of FIG. 2) to perform steps of the claimed method of initiating POS payment transactions.

As illustrated in FIGS. 3A and 3B, in certain embodiments, system 100 may include payer's mobile device 10 (the “payer” may also be referred to herein as the “user,” “customer,” “buyer,” etc.), POS terminal device 20 of a store (the “store” may also be referred to herein as the “merchant”), payment server 30, acquirer bank server 40 (e.g., involved in the maintenance of the merchant's bank account) and issuer bank server 50 (e.g., involved in the maintenance of the customer's bank account).

In certain embodiments, mobile device 10 may include Secure Element (SE) 11.

As known in the art, the Secure Element (SE) 11 (also may referred to as Trusted Execution Environment (TEE), Secure Enclave etc.) may be a tamper-resistant hardware, software, or combined component designed to store sensitive information securely, particularly payment credentials for mobile payment systems. It may provide a secure environment for executing cryptographic operations, ensuring that payment data such as card details and authentication keys are protected against unauthorized access and potential breaches. The SE's robust security architecture may allow for secure storage, processing, and transmission of payment credential data, enabling safe and efficient mobile payment transactions. By isolating sensitive information from other data stored in the device memory (e.g., memory module 3, as shown in FIG. 2), the SE 11 may significantly enhance the security of mobile payment applications.

In certain embodiments, mobile device 10 may store, within SE 11, unique encryption key 11A of the device 10 and payment credentials data 11B of the payer.

In certain embodiments, system 100 may use various known cryptography techniques to transfer data securely from mobile device 10 to payment server 30. E.g., according to known symmetric encryption techniques, at the preliminary stage (e.g., during a registration of a new user in the payment system 100), payment server 30 may generate, using master encryption key of the payment server 30, unique encryption key 11A for the device 10, based on unique information about the mobile device 10 and/or the owner thereof (such as unique identifier of the mobile device 10, ID number of the user, etc.). Payment server 30 may then transfer the unique encryption key 11A to the mobile device 10, to be stored in SE 11. Then, during a payment transaction, the mobile device 10 may use key 11A to encode sensitive data that needs to be transferred to the payment server 30, such as payment credentials data 11B, and/or may use it to generate authentication cryptogram 12B (explained below), based on payment credentials data 11B and transaction-specific data uniquely identifying the POS payment transaction. As only mobile device 10 stores the key 11A, an unauthorized decryption or generation of the authentication cryptogram becomes computationally infeasible. Server 30 may, e.g., either store a copy of the unique encryption key 11A or may re-generate it when needed, based on the unique information about the mobile device 10 and/or the owner thereof, and use it, during the payment transaction, either to decrypt sensitive data or to generate the server's version of the authentication cryptogram to compare it with the authentication cryptogram 12B (also referred herein as cryptogram 12B′ or 12B″) calculated and provided by the mobile device 10, as commonly known in the art.

It should be appreciated that the abovementioned encryption technique is not to be considered exclusive in any respect, and therefore the scope of the present invention, as defined by the appended set of claims, shall not be considered limited to the abovementioned encryption techniques. Accordingly, in some alternative embodiments, other known encryption techniques may be used to transfer sensitive data from the mobile device 10 to the server 30 via any of said parallel network communication pathways, including, e.g., asymmetric encryption (e.g., Public Key Infrastructure (PKI) techniques, that uses public cryptographic keys and digital certificates, which are issued and signed by trusted Certificate Authorities (Cas)), combined symmetric and asymmetric encryption, encryption using session keys, etc.

In certain embodiments, payer's payment credentials data 11B may include: (i) a cardholder information; (ii) a card number or a payment token number; (iii) a card expiry date; (iv) a Card Verification Value (CVV) or a Card Verification Code (CVC); (v) a transaction amount (received from the POS terminal device 20, as explained below).

In certain embodiments, mobile device 10 may further include authentication cryptogram generation module 12 and communication module 13.

POS terminal device 20 may include communication module 21 (such as the communication module 8 explained with reference to FIG. 2) and may be configured to generate an amount 21A to be paid in the ongoing transaction (also referred herein as “transaction amount”), which may be inputted manually via a pin-pad, or retrieved from a designated database automatically, e.g., upon scanning the product bar-code.

In certain embodiments, the POS terminal device 20 may also be configured to generate a first transaction-specific data element 21B, as a part of the transaction-specific data uniquely identifying the ongoing POS payment transaction. In certain embodiments, the first transaction-specific data element 21B may include at least one of (i) a unique identifier of POS terminal device 20; (ii) a random one-time-use code.

In certain embodiments, the mobile device 10 may be further configured to generate a second transaction-specific data element 12A, as a part of the transaction-specific data uniquely identifying the ongoing POS payment transaction. In certain embodiments, the second transaction-specific data element 12A may include, e.g., at least one of (i) a transaction timestamp; (ii) a unique identifier of the mobile device 10 (e.g., Device ID or IMEI (International Mobile Equipment Identity), assigned to the device 10 by the manufacturer, MAC address, etc.) (iii) a random one-time-use code; (iv) a transaction counter (a counter that is stored by the mobile device 10 and incremented after each payment transaction).

In certain embodiments, the payment server 30 may include a communication module 31 (such as the communication module 8 explained with reference to FIG. 2), a verification module 32, and a transaction processing module 33, as shown in FIG. 3B.

In certain embodiments, the mobile device 10 may be configured to generate and transmit the payment transaction data package, including (i) the payer's payment credentials data 11B; and (ii) an authentication cryptogram 12B generated, by the payer's mobile device 10, based on the payer's payment credentials data 11B and a transaction-specific data uniquely identifying the POS payment transaction, from the payer's mobile device 10 to the payment server 30.

Referring now to FIGS. 3A-3B and 4A, a particular embodiment of the present invention is described.

In particular, in the embodiment shown in FIGS. 3A-3B, and 4A, the system 100 may be configured to do the following procedures regarding the transmission of the payment transaction data package from the payer's mobile device 10 to the payment server 30, in particularly in relation to the data transmitted via the first network communication pathway (indicated by elements 111 and 112, as shown in FIGS. 3A-3D).

The mobile device 10 and the POS payment terminal 20 may be configured to establish a short-range wireless communication channel 111 therebetween, using communication modules 13 and 21 (e.g., via procedure 131A, shown in FIG. 4A).

The POS terminal device 20 may be further configured to transmit to the mobile device 10, via the established short-range wireless communication channel 111, the first transaction-specific data element 21B (e.g., via procedure 211A, shown in FIG. 4A). Additionally, in certain embodiments, the POS terminal device 20 may be further configured to transmit, within the same procedure 211A, the transaction amount 21A.

The mobile device 10 may be further configured to supplement the payment credentials data 11B with the amount 21A to be paid. The communication module 13 (such as the communication module 8 explained with reference to FIG. 2) may be further configured to communicate the received data to the authentication cryptogram generation module 12 (e.g., via procedure 132A, shown in FIG. 4A). The authentication cryptogram generation module 12 may be further configured to generate the second transaction-specific data element 12A; and generate the authentication cryptogram 12B, based on the payer's payment credentials data 11B, the first transaction-specific data element 21B and the second transaction-specific data element 12A. E.g., the module 12 may be configured to encrypt the payer's payment credentials data 11B, the first transaction-specific data element 21B and the second transaction-specific data element 12A, using unique encryption key 11A, using known symmetric encryption algorithms, such as Advanced Encryption Standard (AES), Data Encryption Standard (DES), Triple DES (3DES) etc. (e.g., via procedure 121A, shown in FIG. 4A).

The mobile device 10 may be further configured to transmit to the POS terminal device 20, via the established short-range wireless communication channel 111, the authentication cryptogram 12B (e.g., via procedures 122A and 133A, shown in FIG. 4A). Additionally, in certain embodiments, the mobile device 10 may be configured to transfer to the POS terminal device 20, within the same procedures 122A and 133A, the payment credentials data 11B.

The POS terminal device 20 may be further configured to transmit, to the payment server 30, via a first secure network communication channel 112, the authentication cryptogram 12B (e.g., via procedure 212A, shown in FIG. 4A), in association with the first transaction-specific data element 21B. Additionally, in certain embodiments, the POS terminal device 20 may be configured to transfer to the payment server 30, within the same procedure 212A, the payment credentials data 11B.

As further illustrated by the embodiment shown in FIGS. 3A-3B, and 4A, the system 100 may be configured to do the following procedures regarding the transmission of the payment transaction data package from the payer's mobile device 10 to the payment server 30, in particularly in relation to the data transmitted via the second network communication pathway (indicated by element 120, as shown in FIGS. 3A-3D).

The mobile device 10 and the payment server 30 may be configured to establish the second secure network communication channel 120 therebetween, using communication modules 13 and 31 (e.g., via procedure 134A, shown in FIG. 4A). In certain embodiments, this operation may be done upon a request (e.g., via procedure 311A, shown in FIG. 4A) generated by the communication module 31, when the transmission via the first secure network communication channel 112 (e.g., via procedure 212A, shown in FIG. 4A) is completed.

The mobile device 10 may be further configured to transmit to the payment server 30, via the established second secure network communication channel 120, the authentication cryptogram 12B in association with the first transaction-specific data element 21B, using communication modules 12 and 31 (e.g., via procedure 134A, shown in FIG. 4A).

For the matter of clarity, the authentication cryptogram received by the payment server 30 via the first network communication pathway, and the authentication cryptogram received by the payment server 30 via the second network communication pathway, in FIG. 3B (and also in FIGS. 3C and 3D) are marked with different reference numbers: 12B′ and 12B″, respectively.

The communication module 31 may further transmit all the data received via procedures 212A and 134A to the verification module 32, for further processing (e.g., via procedure 312A, shown in FIG. 4A).

As further illustrated by the embodiment shown in FIGS. 3A-3B, and 4A, the verification module 32 of the payment server 30 may be configured to determine, using the association with the first transaction-specific data element 21B, that the authentication cryptograms 12B′ and 12B″ are the ones that need to be compared (e.g., via procedure 321A, shown in FIG. 4A). This action is crucial as the server 30 may simultaneously process multiple payment transactions. The association with the data element 21B, which is generated by the POS terminal device 20, helps to identify the pair of authentication cryptograms from the same payment transaction. Additionally, it introduces another security layer. If the data is compromised, the fraudster would need to know the data generated by the POS terminal device 20 (e.g., data element 21B), associate it with the respective authentication cryptogram, and transmit it via the respective network communication pathway. This significantly hampers the execution of such fraudulent actions.

The verification module 32 may then verify the authentication cryptogram (the two copies of the authentication cryptogram-cryptograms 12B′ and 12B″) to ensure that the payer's payment credentials data are authentic and intended to be used for the POS payment transaction (e.g., within procedure 321A, shown in FIG. 4A).

In particular, according to the embodiment illustrated in FIGS. 3A-3B, and 4A, the verification module 32 may verify that the authentication cryptogram transmitted via the at least one first pathway (e.g., the cryptogram 12B′, transmitted via the pathway shown with elements 111 and 112) matches the authentication cryptogram transmitted via the at least one second pathway (e.g., the cryptogram 12B″, transmitted via the pathway shown with element 120), based on the association with the first transaction-specific data element 21B (e.g., within procedure 321A, shown in FIG. 4A).

Next, the verification module 32 may be configured to generate a verification result 32A, indicating, e.g., (i) whether the verification was successful (e.g., whether the two copies of the authentication cryptogram (elements 12B′ and 12B″) were found; and (ii) whether, after the comparison, it was determined that they are identical). The verification module 32 may further transmit the verification result 32A to the transaction processing module 33 (e.g., within procedure 322A, shown in FIG. 4A).

In certain embodiments, the transaction processing module 33 may be further configured to receive the verification result 32A, and if the result is positive (the verification was successfully completed), may initiate the payment transaction using the payer's payment credentials 11B.

In particular, the transaction processing module 33 may be further configured to initiate a payment request to the issuer bank server 50, via communication module 31 (e.g., via procedures 331A and 313A, shown in FIG. 4A). The issuer bank server 50 may validate the payer's payment credentials data 11B and ensuring sufficient funds are available for the transaction in the payer's account (e.g., via procedure 501A, shown in FIG. 4A). The issuer bank server 50 may then initiate a funds transfer to the acquirer bank server 40 (e.g., via procedure 502A, shown in FIG. 4A). The acquirer bank server 40 may confirm receipt of funds and send a payment confirmation back to the issuer bank server 50 (e.g., via procedure 401A, shown in FIG. 4A). The issuer bank server 50 may forward the payment confirmation to the payment server 30 (e.g., via procedure 503A, shown in FIG. 4A). The payment server 30 may then forward the payment confirmation to the POS terminal device 20 (e.g., via procedure 313A, shown in FIG. 4A), which may then display a “transaction completed” message to the payer.

It shall be understood that the algorithm for settling payment transactions between the acquirer and the issuer (e.g., between the acquirer bank server 40 and the issuer bank server 50) as described above (procedures 501A, 502A, 401A) shall not be considered limiting, and other known approaches may be applied herein. For example, these approaches include so-called “push” payments (such as bank transfers and direct deposits), wherein the issuer (e.g., server 50) initiates the transfer of funds to the payee (e.g., server 40), thereby maintaining control over the payment process, and “pull” payments (such as direct debits), wherein the payee (e.g., server 40) initiates the transfer of funds, having been authorized by the payer (e.g., server 50) to collect funds.

In certain embodiments, the short-range wireless communication channel (shown by element 111 in FIGS. 3A-3D) may be established using at least one of: (i) Near Field Communication (NFC) protocol; (ii) Bluetooth protocol; (iii) Wi-Fi protocol. The first secure network communication channel (shown by element 112 in FIGS. 3A-3D) may be established using at least one of: (i) Transmission Control Protocol/Internet Protocol (TCP/IP); (ii) ISO 8583 over TCP/IP; (iii) Virtual Private Network (VPN) over TCP/IP. The second secure network communication channel (shown by element 120 in FIGS. 3A-3D) may be established using at least one of: (i) TCP/IP; and (ii) VPN over TCP/IP.

It should be appreciated by those skilled in the art that the parallel network communication pathways (e.g., the first pathway illustrated by elements 111 and 112, and the second pathway illustrated by element 120) may have a wide variety of possible implementations utilizing various known network communication protocols. Therefore, the scope of the present invention, as determined by the appended set of claims, shall not be considered limited to the examples provided above.

Reference is now made to FIGS. 3A, 3C and 4B, showing another embodiment of the present method and system.

In this embodiment, the system 100 may be configured to do the following procedures regarding the transmission of the payment transaction data package from the payer's mobile device 10 to the payment server 30, as well as regarding the authentication cryptogram verification.

In this embodiment, the data transmission via the first network communication pathway (indicated by elements 111 and 112, as shown in FIGS. 3A and 3C) may be performed as explained above, in relation to the embodiments of FIGS. 3A-3B and 4A. Accordingly, procedures 131B, 211B, 132B, 121B, 122B, 133B, and 212B of FIG. 4B may be the same as procedures 131A, 211A, 132A, 121A, 122A, 133A, and 212A of FIG. 4A, respectively. For the sake of clarity and conciseness, the discussion of similar procedures is not repeated.

According to the present embodiment (as shown in FIGS. 3A, 3C, and 4B), mobile device 10 may further be configured to transfer the second transaction-specific data element 12A to payment server 30, along with other transmitted data, e.g., via procedures 122B, 133B, and 212B.

After receiving the payment credentials data 11B, the first transaction-specific data element 21B, the second transaction-specific data element 12A and the authentication cryptogram 12B′ via the first network communication pathway (shown by elements 111 and 112), the payment server 30 may proceed with the authentication cryptogram verification starting with generating a server version 35A of the authentication cryptogram.

In particular, payment server 30 may further include a unique key generation module 34. The communication module 31 may transmit (e.g., via procedure 311B, shown in FIG. 4B) to the unique key generation module 34, the payer's payment credentials data 11B (and additionally or alternatively-the second transaction-specific data element 12A). The unique key generation module 34 may further re-generate (e.g., procedure 341B, shown in FIG. 4B), using master encryption key (not shown) of the payment server 30, unique encryption key 11A′, based on unique information about the mobile device 10 (e.g., represented by the second transaction-specific data element 12A, which may be, e.g., the unique identifier of the payer's mobile device 10) and/or the owner thereof (e.g., ID number of the user, PAN of the user, user's name, which may be included into the payment credentials data 11B). It should be understood that, if the data used for key generation was never altered (e.g., by fraud), the unique encryption key 11A′ will represent a copy of the unique encryption key 11A, as originally generated.

It should be appreciated that the aforementioned unique key generation procedure may be performed according to algorithms that are commonly used in the art for this purpose. Examples of such algorithms include the Advanced Encryption Standard (AES), Rivest-Shamir-Adleman (RSA), Elliptic Curve Cryptography (ECC), and Hash-based Message Authentication Code (HMAC). These algorithms are widely recognized for their robustness and security in generating unique keys based on the unique data of the mobile device 10 or the payer, and using the master-key of the payment server 30.

According to the illustrated embodiment, the server 30 may further include an authentication cryptogram generation module 35 (similar to the module 12 of the mobile device 10, as described with reference to FIG. 3A). The unique key generation module 34 may be further configured to transmit the generated unique encryption key 11A′ to the authentication cryptogram generation module 35 (e.g., procedure 342B, shown in FIG. 4B).

The module 35 may be further configured to generate (e.g., procedure 351B shown in FIG. 4B) a server version 35A of the authentication cryptogram, based on the payer's payment credentials data 11B and the transaction-specific data (e.g., the first transaction-specific data element 21B and the second transaction-specific data element 12A), same as the module 12, discussed with reference to FIG. 3A above. The module 35 may be further configured to transfer the server version 35A of the authentication cryptogram to the verification module 32 (e.g., procedure 352B, shown in FIG. 4B). The verification module 32 may be further configured to verify that the server version 35A of the authentication cryptogram matches the authentication cryptogram 12B′ transmitted via the at least one first pathway, e.g., the verification module 32 may compare the two files (the authentication cryptogram 12B′ and the server version 35A of the authentication cryptogram) to check if they are identical (e.g., procedure 321B, shown in FIG. 4B).

In contrast to the embodiment described above with reference to FIGS. 3A, 3B and 4A, in the present embodiment (shown in FIGS. 3A, 3C and 4B), the request from the payment server 30 to the mobile device 10 to transmit the authentication cryptogram via the second pathway (e.g., the request shown by procedure 311A in FIG. 4A) may be transmitted only after the verification procedure described above is successfully completed (e.g., it is determined that the authentication cryptogram 12B′ is identical to the server version 35A of the authentication cryptogram). Accordingly, after completing the procedure 321B, the verification module 32 may transfer the indication of the positive verification result to the communication module 31 (e.g., procedure 322B, shown in FIG. 4B). Upon receiving the abovementioned indication, the communication module 31 may transmit (e.g., procedures 312B and 313B of FIG. 4B) a request to the mobile device 10 (e.g., to the communication module 13) to transmit the authentication cryptogram 12B via the at least one second pathway (shown by element 120 in FIG. 3A).

After that, same as explained above with reference to FIG. 4A, the mobile device 10 and the payment server 30 may be configured to establish the second secure network communication channel 120 therebetween, using communication modules 13 and 31 (e.g., via procedure 134B, shown in FIG. 4B). Then, mobile device 10 may transmit, the authentication cryptogram 12B via the at least one second pathway (shown by element 120 in FIG. 3A) upon the request.

In the present embodiment, after the payment server 30 receives the authentication cryptogram via the first network communication pathway (e.g., the authentication cryptogram 12B′) and the authentication cryptogram via the second network communication pathway (e.g., the authentication cryptogram 12B″), the method of initiating POS payment transactions may proceed in the same manner as discussed above, with reference to the embodiment of FIGS. 3A, 3B and 4A. Accordingly, procedures 314B, 323B, 324B and 331B of FIG. 4B may be the same as procedures 312A, 321A, 322A, and 331A of FIG. 4A, respectively. Next, the method may proceed in the same manner as discussed with reference to procedures 313A, 501A, 502A, 401A, 503A and 313A of FIG. 4A. For the sake of clarity and conciseness, the discussion of similar procedures is not repeated.

Reference is now made to FIGS. 3A, 3D and 4C, showing yet another embodiment of the present system and method.

In this embodiment, the system 100 may be configured to do the following procedures regarding the transmission of the payment transaction data package from the payer's mobile device 10 to the payment server 30, as well as regarding the authentication cryptogram verification. The general idea of this embodiment is that the payer's payment credentials data 11B and the authentication cryptogram 12B are transmitted via different network communication pathways (the first and the second communication pathways, discussed above).

In this embodiment, the data transmission via the first network communication pathway (indicated by elements 111 and 112, as shown in FIGS. 3A and 3D) may be performed as explained in relation to the embodiment of FIGS. 3A-3B and 4A above, with the only difference that the payer's payment credentials data 11B are not transmitted via the first network communication pathway. Accordingly, procedures 131C, 211C, 132C, 121C, 122C, 133C, and 212C of FIG. 4C may be the same as procedures 131A, 211A, 132A, 121A, 122A, 133A, and 212A of FIG. 4A, respectively, except that the procedures 133C and 212C do not include transmission of the payment credentials data 11B. For the sake of clarity and conciseness, the discussion of similar procedures is not repeated.

According to the embodiment of FIGS. 3A, 3D and 4C, after receiving the authentication cryptogram 12B (in FIG. 3D, shown as authentication cryptogram 12B′) via the first network communication pathway (via procedures 133C and 212C), the mobile device 10 and the payment server 30 may be configured to establish the second secure network communication channel 120 therebetween, using the communication modules 13 and 31 (e.g., via procedure 134C, shown in FIG. 4C). In certain embodiments, this operation may be done upon a request (e.g., via procedure 311C, shown in FIG. 4C) generated by communication module 31, when the transmission via the first secure network communication channel 112 (e.g., via procedure 212C, shown in FIG. 4C) is completed.

The mobile device 10 may be further configured to transmit to the payment server 30, via the established second secure network communication channel 120, the payer's payment credentials data 11B in association with the first transaction-specific data element 21B, using communication modules 12 and 31 (e.g., via procedure 134C, shown in FIG. 4C).

Upon receiving the payment credentials data 11B, the payment server 30 may proceed with generating the server version 35A of the authentication cryptogram, based on the payer's payment credentials data 11B and the transaction-specific data (e.g., the first transaction-specific data element 21B, the second transaction-specific data element 12A). In the present embodiment, the generation of the server version 35A may be done in the same manner as described above in relation to the embodiment of FIGS. 3A, 3C and 4B). Accordingly, procedures 312C, 341C, 342C, 351C, and 352C of FIG. 4C may be the same as procedures 311B, 341B, 342B, 351B, and 352B of FIG. 4B, respectively. For the sake of clarity and conciseness, the discussion of similar procedures is not repeated.

The verification module 32 may be further configured to verify that the server version 35A of the authentication cryptogram matches the authentication cryptogram 12B′ transmitted via the at least one first pathway, e.g., the verification module 32 may compare the two files (the authentication cryptogram 12B′ and the server version 35A of the authentication cryptogram) to check if they are identical (e.g., procedure 321C, shown in FIG. 4C). As multiple payment transactions may be processed with the payment server 30 in parallel, to determine which pair of the authentication cryptogram received via the network and the server version of the authentication cryptogram calculated by the server 30 shall be compared, both the server version 35A and the authentication cryptogram 12B′ may be associated with the first transaction-specific data element 21B. Accordingly, the verification module 32 may verify that the server version 35A of the authentication cryptogram matches the authentication cryptogram 12B′ transmitted via the at least one first pathway (e.g., via communication channels shown by elements 111 and 112 in FIGS. 3A and 3C), based on the association with the first transaction-specific data element 21B, i.e., the module 32 may select, for the comparison, files that are stored in association with the element 21B.

After successfully completing the verification, the module 32 may proceed with initiating the payment transaction via procedures 322C and 331C in the same manner, as discussed with reference to procedures 322A and 331A of FIG. 4A. Next, the method may proceed in the same manner as discussed with reference to procedures 313A, 501A, 502A, 401A, 503A and 313A of FIG. 4A. For the sake of clarity and conciseness, the discussion of similar procedures is not repeated.

In known solutions, the necessity of transmitting the payer's payment credentials through the POS terminal device is a well-known drawback, as it significantly increases the chances of this data being stolen. The embodiment shown in FIGS. 3A, 3D, and 4C provides an additional improvement to the field by eliminating the transmission of payment credentials data (e.g., data 11B) through the POS terminal device (e.g., device 20), and transferring it through a secure network communication channel (e.g., the channel shown by element 120) directly to the payment server (e.g., server 30).

The “direct” data transmission from the mobile device 10 to the payment server 30, in the context of the present disclosure, shall be understood as that the transmission is not performed via the POS terminal device 20.

In addition to the benefits of payment transaction security discussed above, the concept of the present invention opens new possibilities for improving the aspects of payer's biometric identification.

It should be noted that commonly used solutions in this technological field today have certain drawbacks. For example, while intended to enhance both security and user experience (since using fingerprint or facial scans significantly increases security and simplifies the identification procedure compared to personal identification numbers (PINs)), the commonly used algorithms often result in redundant actions for the user. A common scenario happens when, at the point of sale (POS), the user starts with placing their mobile device in close proximity to the POS terminal, establishing a short-range wireless communication channel. The user is then asked to confirm their identity using biometrics, which requires them to move the device away from the POS terminal, thereby breaking the connection. After performing the biometric scan (facial or fingerprint), the user must bring their mobile device close to the terminal again to re-establish the communication channel and proceed with the payment transaction data transfer.

The present invention may provide a solution to the abovementioned drawback of the prior art and, furthermore, improve security aspects.

In particular, in some embodiments related to the aspects of the biometric identification, the biometric identification procedure may be moved to another stage. As described above, according to the present invention, in addition to the data transfer between the mobile device 10 and the payment server 30 via the first network communication pathway (via the POS terminal device 20), it is also required to perform data transfer via the second network communication pathway (“directly” from the mobile device 10 to the server 30, bypassing the POS terminal device 20). Hence, in this approach, it becomes no longer crucial to perform biometric identification in order to confirm the data transfer via the POS terminal device 20. Accordingly, the data transfer via the first network communication pathway may be performed seamlessly-without any interruption to perform the biometric identification, which may be instead requested to confirm data transfer via the second network communication pathway. As the data transfer via the second network communication pathway does not involve the POS terminal device 20, after completing the identification, no more actions a required from the user (e.g., the user no longer have to bring their mobile device in close proximity to the POS terminal device again, to re-establish the connection).

Accordingly, in certain embodiments, mobile device 10 may store a reference identification data element, uniquely identifying the authorized user of mobile device 10. In certain embodiments, the reference identification data element may be generated, based on the user biometric data (fingerprint scan, face image, 3D face map etc.). It shall be appreciated that, additionally or alternatively to the biometric data, the reference identification data element may be or may include a numerical or alphanumerical code. The reference identification data element may be generated in advance to performing the payment transaction, e.g., when the user performs registration in system 100 for the first time (as a new user). In certain embodiments, the reference identification data element may be stored exclusively in the memory of mobile device 10. This approach reduces the chances of it being stolen or compromised, thereby enhancing security.

After the transmission via the first network communication pathway is completed (e.g., after the procedure 212A of the embodiment discussed with reference to FIGS. 3A, 3B and 4A; or after the procedures 212B or 321B of the embodiment discussed with reference to FIGS. 3A, 3C and 4B; or after the procedure 212C of the embodiment discussed with reference to FIGS. 3A, 3D and 4C) the user may be requested to perform biometric identification using the mobile device 10. In particular, the user may scan their fingerprint, face image, 3D face map, etc., and the mobile device 10 may be configured to receive, from the user, the scanned biometric data and store it as an input identification data element. It shall be appreciated that, additionally or alternatively to biometric data, the input identification data element may be or may include a numerical or alphanumerical code.

It shall be understood that in certain embodiments, the request to perform the biometric identification may be provided to the user via the mobile device 10 upon receiving the request, from the POS terminal device 20 to perform data transfer via the second network communication pathway (e.g., after the procedure 311A of the embodiment discussed with reference to FIGS. 3A, 3B and 4A; or after the procedure 313B of the embodiment discussed with reference to FIGS. 3A, 3C and 4B; or after the procedure 311C of the embodiment discussed with reference to FIGS. 3A, 3D and 4C). It shall further be understood that procedures 134A, 134B, and 134C of FIGS. 4A, 4B, and 4C, respectively, (as well as the procedures that follow them) shall not be conducted if the biometric identification is not performed or performed with a negative result (the user the provided the biometric data is not confirmed to be an authorized user), and the initiation of the POS payment transaction shall be terminated.

As for the biometric identification itself, in some embodiments, it may be performed in the same way as commonly done in known solutions. For example, the mobile device 10 may compare the input identification data element with the reference identification data element. If they match (i.e., if the two files are identical or, depending on the applied techniques, substantially similar), it may indicate that the user who provided the input identification data element is an authorized user of the mobile device 10. In such a scenario, the biometric identification may be considered successfully completed, allowing the initiation of the POS payment transaction to continue. Otherwise, it indicates that the user who provided the input identification data element is not an authorized user of the mobile device 10, and, accordingly, the biometric identification may be considered completed with a negative result, leading to the termination of the POS payment transaction initiation.

In alternative embodiments, the payment server 30 may act as an authorized entity to perform biometric identification. To perform this, the mobile device 10 may send both the reference identification data element and the input identification data element to the payment server 30. To improve the security of this process, these identification data elements may be transferred to the payment server 30 separately via different network communication pathways. For example, the mobile device 10 may transfer the reference identification data element via the first network communication pathway through the POS terminal device 20 (e.g., depending on the embodiment, within any of procedures 212A of FIGS. 4A, 212B of FIG. 4B, or 212C of FIG. 4C, respectively). The mobile device 10 may further transfer the input identification data element via the second network communication pathway directly to the payment server 30 (e.g., depending on the embodiment, within any of procedures 134A of FIGS. 4A, 134B of FIG. 4B, or 134C of FIG. 4C, respectively). Subsequently, anytime before initiating the payment transaction by the transaction processing module 33 (e.g., before procedures 331A of FIGS. 4A, 331B of FIG. 4B, or 331C of FIG. 4C, respectively), the payment server 30 may perform the biometric identification procedure as described above, by comparing the two identification data elements. If the biometric identification result is positive, the payment server 30 may proceed with initiating the POS payment transaction, whereas if it is negative, it may terminate the transaction initiation.

In yet another alternative embodiment, the reference identification data element may not be transmitted to the payment server 30 during each POS payment transaction but initially stored in the memory of the payment server 30. This can be done, for example, during the initial stage when the respective user is registered in the system 100. The input identification data element, however, may be transmitted from the mobile device 10 to the payment server via the second network communication pathway. The payment server 30 may be configured to perform a biometric identification procedure as explained above.

As can be seen from the provided disclosure, the present invention represents a system and method of initiating POS payment transactions, which provide an improvement of the technological field of contactless payments by adapting and integrating advanced security techniques similar to the ones that are used in online (web) payments into on-site POS payments to enhance cybersecurity, while maintaining the convenience and simplicity of the payment process at the consumer's end.

While the disclosure has been presented and described in relation to different embodiments, it should be appreciated by those skilled in the art that modifications in form and details can be introduced without deviating from the essence and scope of the disclosure as defined by the appended claims and their equivalents.

It should also be understood that each of the presented embodiments does not impose any constraints as for the content of essential features. Accordingly, each of the present embodiments may be combined with others to incorporate their essential features, without deviating from the essence and scope of the present invention.

1. A method of initiating a point-of-sale (POS) payment transaction by a payment server, the method comprising:
receiving, from a payer's mobile device, a payment transaction data package comprising: (i) payer's payment credentials data; and (ii) an authentication cryptogram generated, by the payer's mobile device, based on the payer's payment credentials data and a transaction-specific data uniquely identifying the POS payment transaction, said payment transaction data package being at least partially transmitted from the payer's mobile device to the payment server using parallel network communication pathways at least partially distinct in applied network communication protocols and comprising at least one first pathway involving data transmission through a POS terminal device, and at least one second pathway not involving data transmission through the POS terminal device;
verifying the authentication cryptogram to ensure that the payer's payment credentials data are authentic and intended to be used for the POS payment transaction; and
initiating the POS payment transaction using the payer's payment credentials data.

2. The method of claim 1, wherein the authentication cryptogram is transmitted via both the at least one first pathway and the at least one second pathway; and
wherein said verifying the authentication cryptogram comprises verifying that the authentication cryptogram transmitted via the at least one first pathway matches the authentication cryptogram transmitted via the at least one second pathway.

3. The method of claim 2, wherein said transaction-specific data comprises:
(i) a first transaction-specific data element generated by the POS terminal device; and (ii) a second transaction-specific data element generated by the payer's mobile device; and
wherein the method further comprises transmitting the payment transaction data package from the payer's mobile device to the payment server, comprising:
within the first pathway:
establishing a short-range wireless communication channel between the payer's mobile device and the POS terminal device;
transmitting, from the POS terminal device to the payers'mobile device, via the established short-range wireless communication channel, the first transaction-specific data element;
generating, by the payer's mobile device, the second transaction-specific data element;
generating, by the payer's mobile device, the authentication cryptogram, based on the payer's payment credentials data, the first transaction-specific data element and the second transaction-specific data element;
transmitting, from the payer's mobile device to the POS terminal device, via the established short-range wireless communication channel, the authentication cryptogram;
transmitting, by the POS terminal device to the payment server, via a first secure network communication channel, the authentication cryptogram, in association with the first transaction-specific data element.

4. The method of claim 3, wherein said transmitting the payment transaction data package from the payer's mobile device to the payment server further comprises:
within the second pathway:
establishing a second secure network communication channel between the payer's mobile device and the payment server;
transmitting, from the payer's mobile device to the payment server via the established second secure network communication channel, the authentication cryptogram in association with the first transaction-specific data element; and
wherein said verifying the authentication cryptogram comprises verifying that the authentication cryptogram transmitted via the at least one first pathway matches the authentication cryptogram transmitted via the at least one second pathway, based on the association with the first transaction-specific data element.

5. The method of claim 4, wherein the short-range wireless communication channel is established using at least one of: (i) Near Field Communication (NFC) protocol; (ii) Bluetooth protocol; (iii) Wi-Fi protocol;
wherein the first secure network communication channel is established using at least one of: (i) Transmission Control Protocol/Internet Protocol (TCP/IP); (ii) ISO 8583 over TCP/IP; (iii) Virtual Private Network (VPN) over TCP/IP; and
wherein the second secure network communication channel is established using at least one of: (i) TCP/IP; and (ii) VPN over TCP/IP.

6. The method of claim 4, wherein said first transaction-specific data element comprises at least one of (i) a unique identifier of the POS terminal device; (ii) a random one-time-use code.

7. The method of claim 4, wherein said second transaction-specific data element comprises at least one of (i) a transaction timestamp; (ii) a unique identifier of the payer's mobile device (iii) a random one-time-use code; (iv) a transaction counter.

8. The method of claim 2, wherein
the payer's payment credentials data are transmitted via the at least one first pathway;
wherein said verifying the authentication cryptogram further comprises:
generating, by the payment server, a server version of the authentication cryptogram, based on the payer's payment credentials data and the transaction-specific data;
verifying that the server version of the authentication cryptogram matches the authentication cryptogram transmitted via the at least one first pathway; and
transmitting a request to the mobile device to transmit the authentication cryptogram via the at least one second pathway, provided that the server version of the authentication cryptogram matches the authentication cryptogram transmitted via the at least one first pathway, wherein the authentication cryptogram is transmitted via the at least one second pathway upon the request.

9. The method of claim 1, wherein the authentication cryptogram is transmitted via the at least one first pathway;
wherein the payer's payment credentials data are transmitted via the at least one second pathway;
wherein said verifying the authentication cryptogram comprises:
generating, by the payment server, a server version of the authentication cryptogram, based on the payer's payment credentials data and the transaction-specific data;
verifying that the server version of the authentication cryptogram matches the authentication cryptogram transmitted via the at least one first pathway.

10. The method of claim 9, wherein said transaction-specific data comprises:
(i) a first transaction-specific data element generated by the POS terminal device; and (ii) a second transaction-specific data element generated by the payer's mobile device; and
wherein the method further comprises transmitting the payment transaction data package from the payer's mobile device to the payment server, comprising:
within the first pathway:
establishing a short-range wireless communication channel between the payer's mobile device and the POS terminal device;
transmitting, from the POS terminal device to the payers'mobile device, via the established short-range wireless communication channel, the first transaction-specific data element;
generating, by the payer's mobile device, the second transaction-specific data element;
generating, by the payer's mobile device, the authentication cryptogram, based on the payer's payment credentials data, the first transaction-specific data element and the second transaction-specific data element;
transmitting, from the payer's mobile device to the POS terminal device, via the established short-range wireless communication channel, the authentication cryptogram;
transmitting, by the POS terminal device to the payment server, via a first secure network communication channel, the authentication cryptogram, in association with the first transaction-specific data element.

11. The method of claim 10, wherein said transmitting the payment transaction data package from the payer's mobile device to the payment server further comprises:
within the second pathway:
establishing a second secure network communication channel between the payer's mobile device and the payment server;
transmitting, from the payer's mobile device to the payment server via the established second secure network communication channel, the payer's payment credentials data in association with the first transaction-specific data element;
wherein the server version of the authentication cryptogram is associated with the first transaction-specific data element; and
wherein said verifying that the server version of the authentication cryptogram matches the authentication cryptogram transmitted via the at least one first pathway is performed based on the association with the first transaction-specific data element.

12. The method of claim 11, wherein the short-range wireless communication channel is established using at least one of: (i) Near Field Communication (NFC) protocol; (ii) Bluetooth protocol; (iii) Wi-Fi protocol;
wherein the first secure network communication channel is established using at least one of: (i) Transmission Control Protocol/Internet Protocol (TCP/IP); (ii) ISO 8583 over TCP/IP; (iii) Virtual Private Network (VPN) over TCP/IP; and
wherein the second secure network communication channel is established using at least one of: (i) TCP/IP; and (ii) VPN over TCP/IP.

13. The method of claim 11, wherein said first transaction-specific data element comprises at least one of (i) a unique identifier of the POS terminal device; (ii) a random one-time-use code.

14. The method of claim 11, wherein said second transaction-specific data element comprises at least one of (i) a transaction timestamp; (ii) a unique identifier of the payer's mobile device (iii) a random one-time-use code; (iv) a transaction counter.

15. The method of claim 1, wherein said payer's payment credentials data comprise at least one of: (i) a cardholder information; (ii) a card number or a payment token number; (iii) a card expiry date; (iv) a Card Verification Value (CVV) or a Card Verification Code (CVC); (v) a transaction amount.

16. A system for initiating a point-of-sale (POS) payment transaction, the system comprising a payment server, a POS terminal device and a payer's mobile device, each comprising: a non-transitory memory module, wherein modules of program instructions are stored, and at least one processor associated with the memory module, and configured to execute the modules of program instructions;
whereupon execution of said modules of program instructions
the processors of the payment server, the POS terminal device, and the payer's mobile device are configured to
transmit, from the payer's mobile device to the payment server, a payment transaction data package, by transmitting at least part thereof using parallel network communication pathways at least partially distinct in applied network communication protocols and comprising at least one first pathway involving data transmission through the POS terminal device, and at least one second pathway not involving data transmission through the POS terminal device, said payment transaction data package comprising: (i) payer's payment credentials data; and (ii) an authentication cryptogram generated, by the payer's mobile device, based on the payer's payment credentials data and a transaction-specific data uniquely identifying the POS payment transaction;
the processor of the payment server is further configured to:
verify the authentication cryptogram to ensure that the payer's payment credentials data are authentic and intended to be used for the POS payment transaction; and
initiate the POS payment transaction using the payer's payment credentials data.

17. The system of claim 16, wherein the processors of the payment server, the POS terminal device, and the payer's mobile device are configured to transmit, from the payer's mobile device to the payment server, a payment transaction data package, further by transmitting the authentication cryptogram via both the at least one first pathway and the at least one second pathway; and
wherein the processor of the payment server is further configured to verify the authentication cryptogram by verifying that the authentication cryptogram transmitted via the at least one first pathway matches the authentication cryptogram transmitted via the at least one second pathway.

18. The system of claim 17, wherein said transaction-specific data comprises: (i) a first transaction-specific data element generated by the POS terminal device; and (ii) a second transaction-specific data element generated by the payer's mobile device; and
wherein the processors of the payment server, the POS terminal device, and the payer's mobile device are configured to transmit, from the payer's mobile device to the payment server, a payment transaction data package, further by:
within the first pathway:
establishing a short-range wireless communication channel between the payer's mobile device and the POS terminal device;
transmitting, from the POS terminal device to the payers'mobile device, via the established short-range wireless communication channel, the first transaction-specific data element;
generating, by the payer's mobile device, the second transaction-specific data element;
generating, by the payer's mobile device, the authentication cryptogram, based on the payer's payment credentials data, the first transaction-specific data element and the second transaction-specific data element;
transmitting, from the payer's mobile device to the POS terminal device, via the established short-range wireless communication channel, the authentication cryptogram;
transmitting, by the POS terminal device to the payment server, via a first secure network communication channel, the authentication cryptogram, in association with the first transaction-specific data element.
within the second pathway:
establishing a second secure network communication channel between the payer's mobile device and the payment server;
transmitting, from the payer's mobile device to the payment server via the established second secure network communication channel, the authentication cryptogram in association with the first transaction-specific data element; and
wherein the processor of the payment server is further configured to verify that the authentication cryptogram transmitted via the at least one first pathway matches the authentication cryptogram transmitted via the at least one second pathway, based on the association with the first transaction-specific data element.

19. The system of claim 17, wherein
the processors of the payment server, the POS terminal device, and the payer's mobile device are configured to transmit, from the payer's mobile device to the payment server, a payment transaction data package, further by transmitting the payer's payment credentials data via the at least one first pathway;
wherein the processor of the payment server is further configured to verify the authentication cryptogram further by:
generating, by the payment server, a server version of the authentication cryptogram, based on the payer's payment credentials data and the transaction-specific data;
verifying that the server version of the authentication cryptogram matches the authentication cryptogram transmitted via the at least one first pathway;
transmitting a request to the mobile device to transmit the authentication cryptogram via the at least one second pathway, provided that the server version of the authentication cryptogram matches the authentication cryptogram transmitted via the at least one first pathway; and
wherein the processors of the payment server and the payer's mobile device are further configured to transmit, from the payer's mobile device to the payment server via the established second secure network communication channel, the authentication cryptogram upon the request.

20. The system of claim 16, wherein the processors of the payment server, the POS terminal device, and the payer's mobile device are configured to transmit, from the payer's mobile device to the payment server, a payment transaction data package, by:
transmitting the authentication cryptogram via the at least one first pathway; and
transmitting the payer's payment credentials data via the at least one second pathway;
wherein said at least one processor of the payment server is further configured to verify the authentication cryptogram by:
generating, by the payment server, a server version of the authentication cryptogram, based on the payer's payment credentials data and the transaction-specific data; and
verifying that the server version of the authentication cryptogram matches the authentication cryptogram transmitted via the at least one first pathway.
